(19) United States
(12) Patent Application Publication
(10) Pub. No.: US 2025/0315284 A1
(43) Pub. Date: Oct. 9, 2025

(54) TARGET CONTENT GENERATION METHOD AND SYSTEM THEREOF

(71) Applicant: SAMSUNG SDS CO., LTD., Seoul (KR)

(72) Inventors: Ji Yeon LEE, Seoul (KR); Young Hyun Choi, Seoul (KR); Jin Young Yoo, Seoul (KR); Na Hye Kim, Seoul (KR)

(73) Assignee: SAMSUNG SDS CO., LTD., Seoul (KR)

(21) Appl. No.: 19/071,273

(22) Filed: Mar. 5, 2025

(30) Foreign Application Priority Data
Apr. 5, 2024 (KR) 10-2024-0046551
Sep. 10, 2024 (KR) 10-2024-0123072

(51) Int. Cl. G06F 9/451; G06F 9/38; G06F 11/34

(52) U.S. Cl. CPC G06F 9/453; G06F 9/3865; G06F 11/3438

(57) ABSTRACT

A target content generation method may include receiving a user request for generating target content for a target system and one or more pieces of reference data referenced for generation of the target content; analyzing the user request and the one or more pieces of reference data in conjunction with generative artificial intelligence (AI) and generating target content corresponding to the user request based on the analysis result, wherein the generating of the target content includes: recognizing a purpose of use of the target system and a plurality of execution screens from the user request and the one or more pieces of reference data; extracting information that meets the purpose of use of the target system and rearranging an order of the plurality of execution screens; and generating a user scenario corresponding to the target system and generating target content corresponding to the user scenario.

### CROSS-REFERENCE TO RELATED APPLICATIONS

This application claims the benefit of Korean Patent Application No. 10-2024-0046551, filed on Apr. 5, 2024, and Korean Patent Application No. 10-2024-0123072, filed on Sep. 10, 2024 in the Korean Intellectual Property Office, the disclosure of which is incorporated herein in its entirety by references.

### BACKGROUND

### 1. Field

The present disclosure relates to a target content generation method and system thereof, and more particularly, to a method of generating target content using generative artificial intelligence (AI) and a system to which the method is applied.

### 2. Description of the Related Art

Service providers who provide products/services related to a system must provide users with onboarding content, user manuals, etc. for the products/services, so that the users can conveniently use the products/services. In addition, there is a need to receive feedback from the users of the products/services and improve or update the system based on feedback information.

Here, tasks need to be performed at respective steps, such as discovering a use case based on a system flow related to a product/service, designing a detailed user operation flow or process for the use case, writing improvements/updates for the system from a user's perspective, producing quick guide content for the system, producing tutorial content, producing a guide video, producing a manual, and producing a sales toolkit. In this case, many workers who can perform the tasks at the respective steps are required. The workers spend a lot of time and effort in the process of performing the tasks at the respective steps and also need to collaborate with workers performing other tasks. In addition, since a final output is generated through many workers, there may be many cases where the final output provided to a user does not meet the needs of the user.

Therefore, it is required to come up with a technology that can improve the work efficiency of workers and produce an output that meets the needs of a user.

### CITATION LIST

### Patent Literature

Korean Patent Publication No. 2024-001305 (published on Jan. 3, 2024)

### SUMMARY

Aspects of the present disclosure provide a method and system capable of generating target content, which meets a user request for a target system.

Aspects of the present disclosure also provide a method and system capable of quickly and easily generating target content for a target system using generative artificial intelligence (AI).

Aspects of the present disclosure also provide a method and system capable of reducing the man-hours and time consumed by a worker in a process of generating target content for a target system.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for A target content generation system. The method may comprise a user request receiving module receiving a user request which comprises information about a purpose and a type of generation of target content for a target system; a data receiving module receiving one or more pieces of reference data which are referenced for the generation of the target content; and a data processing module analyzing the user request and the one or more pieces of reference data in conjunction with generative artificial intelligence (AI) and generating target content corresponding to the user request based on the analysis result, wherein the data processing module comprises: a recognition unit recognizing a purpose of use of the target system and a plurality of execution screens from the user request and the one or more pieces of reference data; a processing unit extracting information that meets the purpose of use of the target system and rearranging an order of the plurality of execution screens; and a construction unit constructing a user scenario corresponding to the target system.

In some embodiments, the one or more pieces of reference data comprise at least one of an execution screen image of the target system, detailed information of the target system, and user feedback information on the target system.

In some embodiments, the data processing module determines a type of the target content for the target system based on the result of analyzing the user request and the one or more pieces of reference data.

In some embodiments, the data processing module generates the target content corresponding to the user request based on a step-by-step plan, and further comprising an exception handling module processing at

In some embodiments, the data processing module analyzes information about a user's history of operating a screen of the target system and transmits an exception handling request signal to the exception handling module based on the analysis result.

In some embodiments, the data processing module analyzes whether the target content meets the user request and transmits an exception handling request signal to the exception handling module based on the analysis result.

In some embodiments, the target content is generated differently based on at least one of the user request, the one or more pieces of reference data, and the user scenario.

In some embodiments, the target content comprises at least one of guide content and promotional content for the target system.

According to another aspect of the present disclosure, there is provided a target content generation method performed by at least one computing device. The method may comprise receiving a user request for generating target content for a target system and one or more pieces of reference data referenced for generation of the target content, and analyzing the user request and the one or more pieces of reference data in conjunction with generative artificial intelligence (AI) and generating target content corresponding to the user request based on the analysis result, wherein the generating of the target content comprises: recognizing a purpose of use of the target system and a plurality of execution screens from the user request and the one or more pieces of reference data, extracting information that meets the purpose of use of the target system and rearranging an order of the plurality of execution screens, and generating a user scenario corresponding to the target system and generating target content corresponding to the user scenario.

In some embodiments, the one or more pieces of reference data comprise at least one of an execution screen image of the target system, detailed information of the target system, and user feedback information on the target system.

In some embodiments, the generating of the target content further comprises determining a type of the target content for the target system based on the result of analyzing the user request and the one or more pieces of reference data.

In some embodiments, the generating of the target content further comprises generating a step-by-step plan for generating the target content, and processing an unprocessable step if at least one unprocessable step exists among a plurality of steps included in the step-by-step plan.

In some embodiments, the unprocessable step is determined based on the result of analyzing information about a user's history of operating a screen of the target system.

In some embodiments, the unprocessable step is determined based on whether the target content meets the user request.

In some embodiments, the target content is generated differently based on at least one of the user request, the one or more pieces of reference data, and the user scenario.

In some embodiments, the target content comprises at least one of guide content and promotional content for the target system.

According to another aspect of the present disclosure, there is provided a non-transitory computer-readable recording medium storing computer program coupled to a computing device. The computer program may execute receiving a user request for generating target content for a target system and one or more pieces of reference data referenced for generation of the target content, and analyzing the user request and the one or more pieces of reference data in conjunction with generative artificial intelligence (AI) and generating target content corresponding to the user request based on the analysis result, wherein the generating of the target content comprises recognizing a purpose of use of the target system and a plurality of execution screens from the user request and the one or more pieces of reference data, extracting information that meets the purpose of use of the target system and rearranging an order of the plurality of execution screens, and generating a user scenario corresponding to the target system and generating target content corresponding to the user scenario.

### BRIEF DESCRIPTION OF THE DRAWINGS

These and/or other aspects will become apparent and more readily appreciated from the following description of the embodiments, taken in conjunction with the accompanying drawings in which:

FIG. 1 is an example diagram illustrating the configuration of a target content generation system according to embodiments of the present disclosure;

FIG. 2 is an example diagram illustrating the configuration of a target content generation system and the flow of a target content generation method according to embodiments of the present disclosure;

FIG. 3 is a flowchart illustrating a target content generation method according to an embodiment of the present disclosure;

FIG. 4 is a diagram for explaining some operations illustrated in FIG. 3;

FIG. 5 is a diagram for explaining some operations illustrated in FIG. 4;

FIG. 6 is a flowchart illustrating a target content generation method according to embodiments of the present disclosure; and

FIG. 7 illustrates the hardware configuration of a target content generation system according to embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

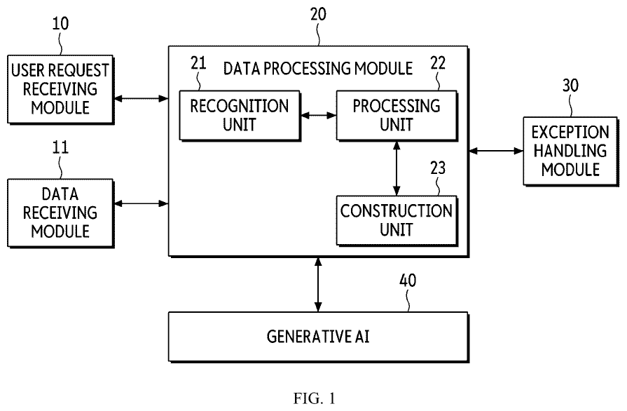

First, a plurality of modules included in a target content generation system according to embodiments of the present disclosure and a process performed by each of the modules will be described with reference to FIG. 1.

FIG. 1 is an example diagram illustrating the configuration of a target content generation system according to embodiments of the present disclosure. However, the target content generation system according to the embodiments of the present disclosure is not limited to that illustrated in FIG. 1, and some elements/modules can be omitted or added as needed.

As illustrated in FIG. 1, the target content generation system according to the embodiments of the present disclosure may include a user request receiving module 10 which receives a user request including information about a purpose and a type of generation of target content for a target system, a data receiving module 11 which receives one or more pieces of reference data referenced for the generation of the target content, and a data processing module 20 which analyzes the user request and the one or more pieces of reference data in conjunction with generative artificial intelligence (AI) 40 and generates target content corresponding to the user request based on the analysis result.

In some embodiments, the one or more pieces of reference data may include at least one of an execution screen image of the target system, detailed information of the target system, and user feedback information on the target system.

More specifically, the one or more pieces of reference data may include a system screen image such as Figma, a development screen image of the system, an execution screen image of the system, function information of the system, concept information of the system, configuration information of the system, customer requirement information related to the system, type information of actual users of the system, user research information about the system, and request for proposal (RFP) report information about the system. That is, the one or more pieces of reference data may include all forms of information that can be utilized together with the user request to identify information about the target system and generate target content for the target system.

The data processing module 20 may include a recognition unit 21 which recognizes a purpose of use of the target system and a plurality of execution screens from the user request and the one or more pieces of reference data, a processing unit 22 which extracts information that meets the purpose of use of the target system and rearranges an order of the execution screens, and a construction unit 23 which constructs a user scenario corresponding to the target system. Here, the recognition unit 21 may perform a character recognition (e.g., optical character recognition (OCR)) process to understand the configuration of each screen of the system based on the purpose of use of the target system.

In some embodiments, the data processing module 20 may determine a type/kind of target content to be generated for the target system based on the result of analyzing the user request and the one or more pieces of reference data. For example, the user request and the reference data may be analyzed using the generative AI, and target content in any one of text, image, and video forms/types which is determined to be suitable for the target system may be generated based on the analysis result.

In some embodiments, the data processing module 20 may generate the target content corresponding to the user request based on a step-by-step plan. Here, the step-by-step plan may refer to a plan for processing a task of generating the target content corresponding to the target system based on the result of analyzing the user request and the reference data. In addition, the step-by-step plan may be generated by the generative AI which has received a prompt generated based on the user request and the reference data.

The target content generation system illustrated in FIG. 1 may further include an exception handling module 30 which processes at least one unprocessable step among a plurality of steps included in the step-by-step plan generated through interworking between the data processing module 20 and the generative AI.

In an embodiment, the data processing module 20 may analyze information about a user's history of operating a screen of the target system and may transmit an exception handling request signal to the exception handling module 30 based on the analysis result.

For example, the data processing module 20 may analyze the user's history of operating the screen of the system using the generative AI, and, if the user's operation history does not match the flow of a predefined operation guide, may determine that an exception has occurred and transmit a request signal for requesting handling of the exception to the exception handling module 30. Then, the exception handling module 30 may perform a process of rearranging a screen order of the target system or reanalyzing the user request and the reference data for the target system.

In an embodiment, the data processing module 20 may analyze whether target content meets the user request and may transmit an exception handling request signal to the exception handling module 30 based on the analysis result.

For example, the data processing module 20 may determine whether target content or target content generation guide information generated for the target system meets an initial user request by using the generative AI and, if the target content or the target content generation guide information is not sufficiently relevant to the user request, may determine that an exception has occurred and transmit a request signal for requesting handling of the exception to the exception handling module 30. Then, the exception handling module 30 may perform a process of reanalyzing the user request and the reference data for the target system.

In some embodiments, the target content may be generated differently based on at least one of the user request, the one or more pieces of reference data, and the user scenario.

That is, the type of the target content may vary according to the user request. For example, if the user request includes “please produce video content containing an audio guide for system A,” the target content may be generated as user guide video content for system A.

Similarly, the type or content of the target content may vary according to the type, number, etc. of pieces of reference data input to the data receiving module 11 and may vary according to the type or content of the user scenario generated by the construction unit 23.

In some embodiments, the target content may include at least one of guide content and promotional content for the target system. More specifically, the target content may include guide content (e.g., user manual, quick guide video, tutorial video) including how to use the target system, description of functions and comparison with other systems, promotional content (e.g., sales toolkit, promotional video, pamphlet), and feedback content (e.g., system improvement plan). That is, the target content may refer to all content of various types and contents related to the introduction or promotion of the target system.

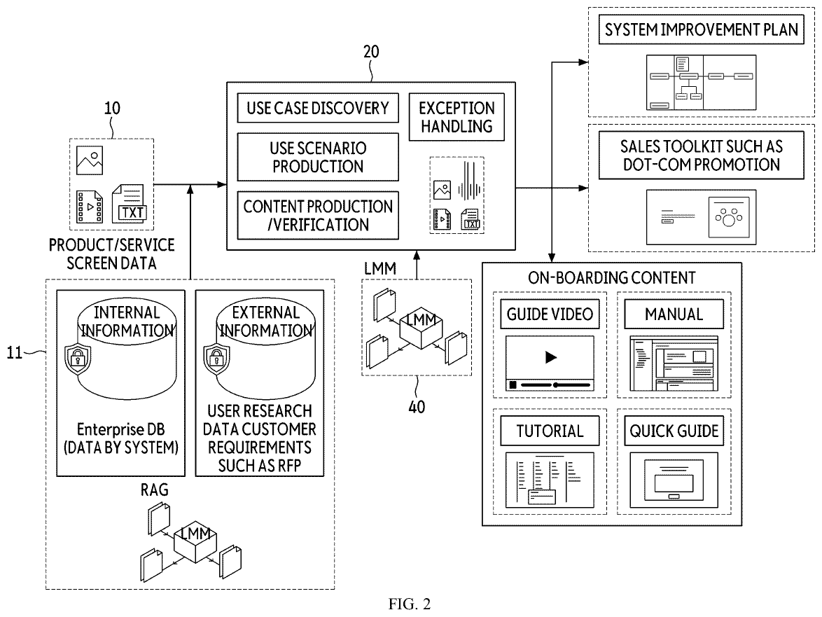

FIG. 2 is an example diagram illustrating the configuration of a target content generation system and the flow of a target content generation method according to embodiments of the present disclosure. The illustration in FIG. 2 is intended to help understand an operation/step performed by each of the elements/modules illustrated in FIG. 1. The illustration in FIG. 1 will be more clearly understood from FIG. 2.

As illustrated in FIG. 2, the target content generation system according to the embodiments of the present disclosure may include a user request receiving module 10 which receives a user request including product/service screen image data related to a target system, a data receiving module 11 which receives reference data from an internal information database (DB) including various types of information about the target system or an external information DB including user research/feedback information about the target system, and a data processing module 20 which generates a user scenario, actual use information and target content by analyzing the user request and the reference data and handles an exception occurring during the generation process.

The data processing module 20 may generate target content or verify the generated target content by analyzing the user request and the reference data in conjunction with generative AI 40. The process of handling an exception occurring during the process of generating the target content may also be performed by a module (i.e., the exception handling module 30 illustrated in FIG. 1) separate from the data processing module 20.

The data processing module 20 may generate different target content according to the user request, the reference data, and the analysis result of the generative AI 40. As illustrated in FIG. 2, the data processing module 20 may generate various types/kinds of onboarding content (e.g., guide video content, user manual content, tutorial video content, quick guide video content, etc.) for the target system. In addition, the data processing module 20 may include text, image or video content containing improvement plans for the target system and text, image or video content (e.g., sales toolkit) containing promotional content for the system.

In summary, the target content generation system may generate various target content in conjunction with the generative AI based on one or more pieces of reference data related to a target system and a user request regarding a purpose or method of generating the target content. More specifically, the user request and the reference data may be analyzed to analyze a purpose of a user who is expected to use the target system, a screen image of the target system, feedback information of existing users, etc. Then, target content may be generated through a process of rearranging an order of system screen images to meet the user request or constructing an expected user scenario.

In the past, when generating target content for a target system, a person in charge (e.g., a product/service designer, a content creator, a digital marketing manager) performed a task at each step. Therefore, a lot of time was consumed in a content generation process. However, according to the present disclosure, the content generation process can be performed at a time in conjunction with the generative AI. That is, user convenience and satisfaction can be improved.

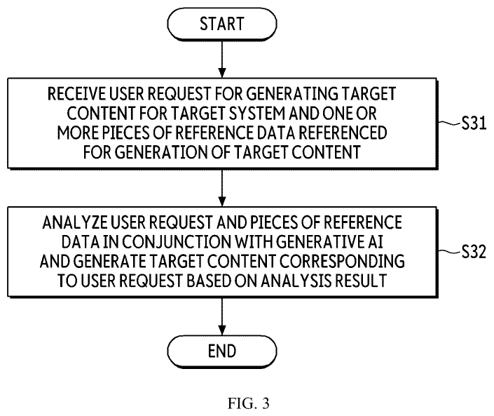

Until now, the target content generation system according to the embodiments of the present disclosure has been described with reference to FIGS. 1 and 2. Hereinafter, a target content generation method according to embodiments of the present disclosure will be described with reference to FIGS. 3 through 6. Operations/steps illustrated in FIGS. 3 through 6 may be performed by at least one of the elements/modules illustrated in FIGS. 1 and 2. A detailed description of elements and features identical to those described above with reference to FIGS. 1 and 2 will be omitted.

FIG. 3 is a flowchart illustrating a target content generation method according to an embodiment of the present disclosure. However, this is only an embodiment for achieving the objectives of the present disclosure, and some operations can be added or deleted as needed,

As illustrated in FIG. 3, the target content generation method according to the embodiment of the present disclosure may include receiving a user request for generating target content for a target system and one or more pieces of reference data referenced for generation of the target content by using a target content generation system in operation S31 and analyzing the user request and the one or more pieces of reference data in conjunction with generative AI and generating target content corresponding to the user request based on the analysis result by using the target content generation system in operation S32.

Here, operation S31 may be performed by the user request receiving module 10 and the data receiving module 11 illustrated in FIG. 1, and operation S32 may be performed by the data processing module 20, the exception handling module 30 and the generative AI 40 illustrated in FIG. 1.

In some embodiments, the reference data referenced for the generation of the target content may include an execution screen image (e.g., Figma screen image) of the system, detailed functions of the system, specifications, user manual information, and user feedback information (e.g., RFP report) on the system.

The data processing module may analyze the user request and the reference data in conjunction with the generative AI and determine an optimal target content generation type (e.g., text, image, or video) that meets the user request based on the analysis result.

In addition, the data processing module may analyze the user request and the reference data in conjunction with the generative AI, may construct/produce a user scenario for the target system based on the analysis result, and may determine the type of target content (e.g., quick guide video content, promotional content, manual, tutorial video, etc. for the system) most suitable for a user based on the user scenario.

FIG. 4 is a diagram for explaining some operations illustrated in FIG. 3. However, this is only an embodiment for achieving the objectives of the present disclosure, and some operations can be added or deleted as needed.

As illustrated in FIG. 4, in some embodiments, the analyzing of the user request and the one or more pieces of reference data in conjunction with the generative AI and the generating of the target content corresponding to the user request based on the analysis result in operation S32 may include recognizing a purpose of use of the target system and a plurality of execution screens from the user request and the one or more pieces of reference data in operation S41, extracting information that meets the purpose of use of the target system and rearranging an order of the execution screens in operation S42, and generating a user scenario corresponding to the target system and generating target content corresponding to the user scenario in operation S43.

That is, the target content generation system may rearrange an order of screens to meet a user's intention and purpose for the target system, construct a system demonstration scenario suitable for the user, and generate user-customized target content for the target system by analyzing the user request and the reference data in conjunction with the generative AI.

Here, operation S41 illustrated in FIG. 4 may be performed by the recognition unit 21 of the data processing module 20 illustrated in FIG. 1, operation S42 may be performed by the processing unit 22 of the data processing module 20 illustrated in FIG. 1, and operation S43 may be performed by the construction unit 23 of the data processing module 20 illustrated in FIG. 1.

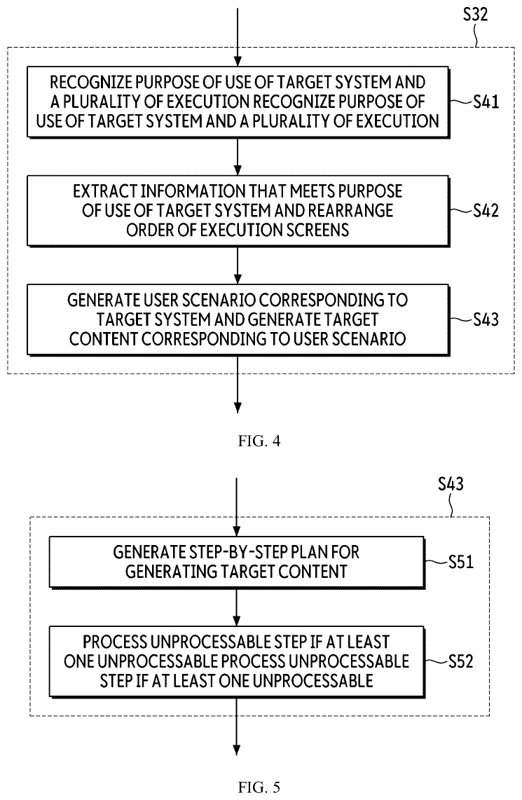

FIG. 5 is a detailed flowchart illustrating some operations illustrated in FIG. 4. However, this is only an embodiment for achieving the objectives of the present disclosure, and some operations can be added or deleted as needed. In addition, operations/steps illustrated in FIG. 5 may be performed by the data processing module 20 and the exception handling module 30 illustrated in FIG. 1.

As illustrated in FIG. 5, in some embodiments, the generating of the user scenario corresponding to the target system and the generating of the target content corresponding to the user scenario in operation S43 may include generating a step-by-step plan for generating the target content by using the data processing module in operation S51 and processing an unprocessable step using the exception handling module if at least one unprocessable step exists among a plurality of steps included in the plan in operation S52.

More specifically, the data processing module may generate a step-by-step plan for generating target content for the target system. Here, the plan may be generated by the generative AI as a result of inputting the user request and information about the target system (i.e., reference data) to the generative AI.

Next, if the data processing module determines that an unprocessable step exists among the steps included in the plan, it may transmit a request signal for requesting processing of the unprocessable step to the exception handling module, and the exception handling module may process the unprocessable step.

In an embodiment, the data processing module may analyze information about a user's history of operating a screen of the target system and identify one or more unprocessable steps among the steps included in the plan based on the analysis result.

For example, the data processing module may analyze the user's history of operating the screen of the system using the generative AI and, if the user's operation history does not match the flow of a predefined operation guide, may determine that an exception has occurred and transmit a request signal for requesting handling of the exception to the exception handling module. Then, the exception handling module may perform a process of rearranging a screen order of the target system or reanalyzing the user request and the reference data for the target system.

In an embodiment, the data processing module may analyze whether target content meets the user request and identify one or more unprocessable steps among the steps included in the plan based on the analysis result.

For example, the data processing module may determine whether target content or target content generation guide information generated for the target system meets an initial user request by using the generative AI and, if the target content or the target content generation guide information is not sufficiently relevant to the user request, may determine that an exception has occurred and transmit a request signal for requesting handling of the exception to the exception handling module. Then, the exception handling module may perform a process of reanalyzing the user request and the reference data for the target system.

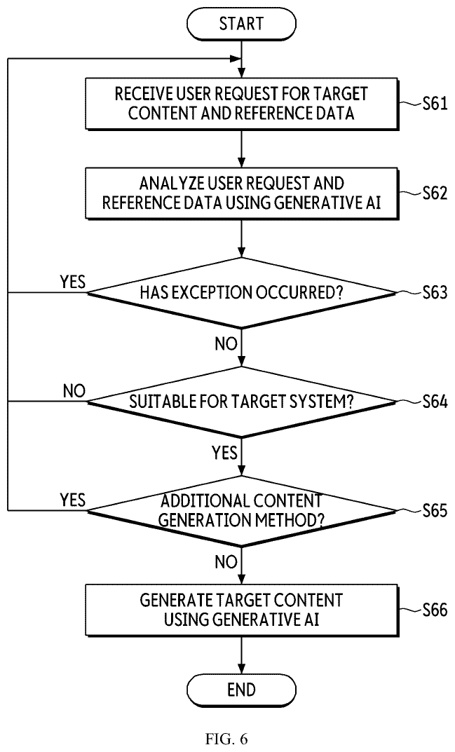

FIG. 6 is a flowchart illustrating a target content generation method according to embodiments of the present disclosure. However, this is only an embodiment for achieving the objectives of the present disclosure, and some operations can be added or deleted as needed.

FIG. 6 is an example flowchart illustrating the process described with reference to FIGS. 1 through 5. The descriptions given with reference to FIGS. 1 through 5 will be more clearly understood from FIG. 6. The flow illustrated in FIG. 6 is identical to that described with reference to FIGS. 1 through 5, and thus a detailed description thereof will be omitted.

As illustrated in FIG. 6, the target content generation method according to the embodiments of the present disclosure may start with operation S61 in which a target content generation system receives a user request for target content and reference data. Here, the user request may be related to a purpose and method of generating target content for a target system. In addition, the target content generation system may receive the reference data (e.g., system development/execution screen image, system configuration/function information, customer requirement information, actual user type information) related to the target system.

In operation S62, a data processing module of the target content generation system may analyze the user request and the reference data using generative AI. The data processing module may recognize a purpose of use (e.g., personnel, purchasing, manufacturing) of the target system from the user request and the reference data in conjunction with the generative AI and may also recognize characters/text for understanding the configuration of each screen based on the purpose of use of the target system. In addition, the data processing module may extract information that meets the purpose of use of the target system from the user request and the reference data in conjunction with the generative AI, may rearrange an order of a plurality of execution screens based on the extracted information, and may construct/generate a user scenario corresponding to the target system.

Since operation S62 has been described in detail above with reference to FIGS. 1 through 5, any repetitive detailed description thereof will be omitted.

In operation S63, the target content generation system may determine whether an exception has occurred in the process of generating the target content. If it is determined that an exception has occurred, the process of receiving the user request for the target content and the reference data and analyzing the user request and the reference data using the generative AI may be performed again.

In an embodiment, the target content generation system may analyze information about a user's history of operating a screen of the target system and, if the user's operation history does not match the flow of a predefined operation guide, may determine that an exception has occurred.

In an embodiment, the target content generation system may determine whether target content or target content generation guide information generated for the target system meets an initial user request by using the generative AI and, if the target content or the target content generation guide information is not sufficiently relevant to the user request, may determine that an exception has occurred.

In an embodiment, the target content generation system may determine that an exception has occurred if an unprocessable step exists in a step-by-step plan for generating target content for the target system.

Since operation S63 has been described in detail above with reference to FIGS. 1 through 5, any repetitive detailed description thereof will be omitted.

In operation S64, the target content generation system may determine whether candidate content or a target content generation guide/plan generated as a result of the analysis is suitable for the target system. If the candidate content or the target content generation guide/plan is determined to be unsuitable for the target system, the process of receiving the user request for the target content and the reference data and analyzing the user request and the reference data using the generative AI may be performed again. Here, whether the candidate content or the target content generation guide/plan is suitable for the target system may be determined by the generative AI.

In operation S65, the target content generation system may determine whether additional content suitable for the target system is required based on the result of analyzing the user request and the reference data. More specifically, it may be determined whether all information required for generation of target content for the target system exists, whether there is no information to be added to the target content generation plan, and whether the plan for the target content to be generated is suitable. If it is determined that additional content suitable for the target system is required, the process of receiving the user request for the target content and the reference data and analyzing the target content and the reference data using the generative AI may be performed again.

Until now, the target content generation method and system according to the embodiments of the present disclosure have been described with reference to FIGS. 1 through 6. According to the target content generation method and system according to the embodiments of the present disclosure, various target content that meets the needs of a user can be generated using generative AI based on one or more pieces of reference data related to a target system and a user request regarding a purpose or method of generating the target content. More specifically, the user request and the reference data may be analyzed to analyze a purpose of a user who is expected to use the target system, a screen image of the target system, feedback information of existing users, etc. in detail. Then, optimal target content can be generated through a process of rearranging an order of system screen images to meet the user request or constructing an expected user scenario.

Accordingly, when target content (e.g., promotional content, onboarding content, guide content) for the target system is generated, the intervention of a plurality of experts at respective steps is not required. Therefore, the man-hours and time consumed in generating the target content can be effectively reduced, and user convenience can be improved. In addition, since the optimal content that meets the needs of a user is provided to the user, user satisfaction and usability can be improved.

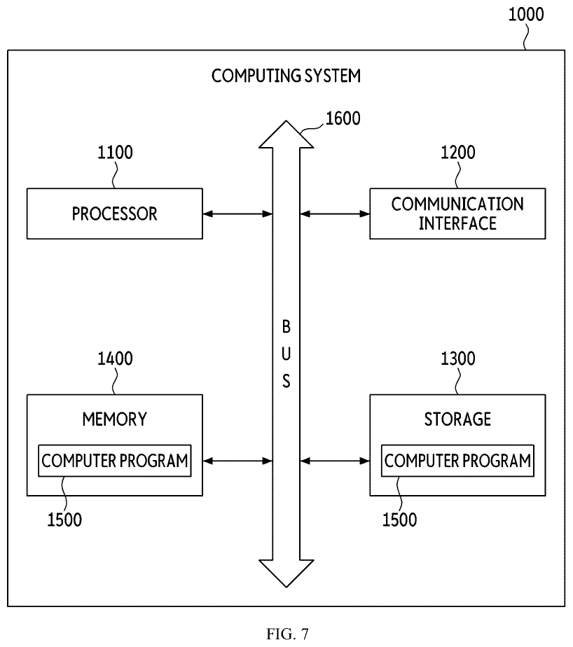

FIG. 7 illustrates the hardware configuration of a target content generation system 1000 according to embodiments of the present disclosure. The target content generation system 1000 illustrated in FIG. 7 may include one or more processors 1100, a system bus 1600, a communication interface 1200, a memory 1400 which loads a computer program 1500 to be executed by the processors 1100, and a storage 1300 which stores the computer program 1500.

The processors 1100 control the overall operation of each element of the target content generation system 1000. The processors 1100 may perform an operation on at least one application or program for executing methods/operations according to various embodiments of the present disclosure. The memory 1400 stores various data, commands and/or information. The memory 1400 may load one or more computer programs 1500 from the storage 1300 in order to execute the methods/operations according to the various embodiments of the present disclosure. The system bus 1600 provides a communication function between the elements of the target content generation system 1000. The communication interface 1200 supports Internet communication of the target content generation system 1000. The storage 1300 may non-temporarily store the programs 1500. The computer programs 1500 may include one or more instructions which implement the methods/operations according to the various embodiments of the present disclosure. When the computer programs 1500 are loaded into the memory 1400, the processors 1100 may perform the methods/operations according to the various embodiments of the present disclosure by executing the instructions.

In some embodiments, the target content generation system 1000 described with reference to FIG. 7 may be configured using one or more physical servers included in a server farm based on cloud technology such as a virtual machine. In this case, at least some of the elements illustrated in FIG. 7, such as the processors 1100, the memory 1400 and the storage 1300, may be virtual hardware, and the communication interface 1200 may be configured as a virtualized networking element such as a virtual switch.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

Various embodiments of the present disclosure and effects according to the embodiments have been described above with reference to FIGS. 1 through 7. However, the effects according to the technical spirit of the present disclosure are not restricted to the one set forth herein. The above and other effects of the present disclosure will become more apparent to one of daily skill in the art to which the present disclosure pertains by referencing the claims.

According to a current embodiment, various target content that meets the needs of a user can be generated using generative AI based on one or more pieces of reference data related to a target system and a user request regarding a purpose or method of generating the target content.

According to the current embodiment, when target content for the target system is generated in a process composed of a plurality of steps, the intervention of a plurality of experts at the respective steps is not required. Therefore, the man-hours and time consumed in generating the target content can be effectively reduced, and user convenience can be improved.

According to the current embodiment, since optimal content that meets the needs of a user is provided to the user, user satisfaction and usability can be improved.

However, aspects of the present disclosure are not restricted to the one set forth herein. The above and other aspects of the present disclosure will become more apparent to one of ordinary skill in the art to which the present disclosure pertains by referencing the claims below.

What is claimed is:

1. A target content generation system comprising:
a user request receiving module receiving a user request which comprises information about a purpose and a type of generation of target content for a target system;
a data receiving module receiving one or more pieces of reference data which are referenced for the generation of the target content; and
a data processing module analyzing the user request and the one or more pieces of reference data in conjunction with generative artificial intelligence (AI) and generating target content corresponding to the user request based on the analysis result,
wherein the data processing module comprises:
a recognition unit recognizing a purpose of use of the target system and a plurality of execution screens from the user request and the one or more pieces of reference data;
a processing unit extracting information that meets the purpose of use of the target system and rearranging an order of the plurality of execution screens; and
a construction unit constructing a user scenario corresponding to the target system.

2. The target content generation system of claim 1, wherein the one or more pieces of reference data comprise at least one of an execution screen image of the target system, detailed information of the target system, and user feedback information on the target system.

3. The target content generation system of claim 1, wherein the data processing module determines a type of the target content for the target system based on the result of analyzing the user request and the one or more pieces of reference data.

4. The target content generation system of claim 1, wherein the data processing module generates the target content corresponding to the user request based on a step-by-step plan, and further comprising an exception handling module processing at least one unprocessable step among a plurality of steps included in the step-by-step plan.

5. The target content generation system of claim 4, wherein the data processing module analyzes information about a user's history of operating a screen of the target system and transmits an exception handling request signal to the exception handling module based on the analysis result.

6. The target content generation system of claim 4, wherein the data processing module analyzes whether the target content meets the user request and transmits an exception handling request signal to the exception handling module based on the analysis result.

7. The target content generation system of claim 1, wherein the target content is generated differently based on at least one of the user request, the one or more pieces of reference data, and the user scenario.

8. The target content generation system of claim 7, wherein the target content comprises at least one of guide content and promotional content for the target system.

9. A target content generation method performed by at least one computing device, the method comprising:
receiving a user request for generating target content for a target system and one or more pieces of reference data referenced for generation of the target content; and
analyzing the user request and the one or more pieces of reference data in conjunction with generative artificial intelligence (AI) and generating target content corresponding to the user request based on the analysis result,
wherein the generating of the target content comprises:
recognizing a purpose of use of the target system and a plurality of execution screens from the user request and the one or more pieces of reference data;
extracting information that meets the purpose of use of the target system and rearranging an order of the plurality of execution screens; and
generating a user scenario corresponding to the target system and generating target content corresponding to the user scenario.

10. The target content generation method of claim 9, wherein the one or more pieces of reference data comprise at least one of an execution screen image of the target system, detailed information of the target system, and user feedback information on the target system.

11. The target content generation method of claim 9, wherein the generating of the target content further comprises determining a type of the target content for the target system based on the result of analyzing the user request and the one or more pieces of reference data.

12. The target content generation method of claim 9, wherein the generating of the target content further comprises:
generating a step-by-step plan for generating the target content; and
processing an unprocessable step if at least one unprocessable step exists among a plurality of steps included in the step-by-step plan.

13. The target content generation method of claim 12, wherein the unprocessable step is determined based on the result of analyzing information about a user's history of operating a screen of the target system.

14. The target content generation method of claim 12, wherein the unprocessable step is determined based on whether the target content meets the user request.

15. The target content generation method of claim 9, wherein the target content is generated differently based on at least one of the user request, the one or more pieces of reference data, and the user scenario.

16. The target content generation method of claim 9, wherein the target content comprises at least one of guide content and promotional content for the target system.

17. A non-transitory computer-readable recording medium storing computer program coupled to a computing device to execute:
receiving a user request for generating target content for a target system and one or more pieces of reference data referenced for generation of the target content; and
analyzing the user request and the one or more pieces of reference data in conjunction with generative artificial intelligence (AI) and generating target content corresponding to the user request based on the analysis result,
wherein the generating of the target content comprises:
recognizing a purpose of use of the target system and a plurality of execution screens from the user request and the one or more pieces of reference data;
extracting information that meets the purpose of use of the target system and rearranging an order of the plurality of execution screens; and
generating a user scenario corresponding to the target system and generating target content corresponding to the user scenario.
